(19) United States
(12) Patent Application Publication
(10) Pub. No.: US 2025/0379444 A1
(43) Pub. Date: Dec. 11, 2025

(54) Model-free Adaptive Dynamic Voltage Control Method Considering Multi-inverter Coordination

(71) Applicant: TSINGHUA UNIVERSITY, BEIJING (CN)

(72) Inventors: WENCHUAN WU, BEIJING (CN); SIYUN LI, BEIJING (CN); BIN WANG, BEIJING (CN); CHENHUI LIN, BEIJING (CN); HAOTIAN LIU, BEIJING (CN); HONGBIN SUN, BEIJING (CN); QINGLAI GUO, BEIJING (CN)

(21) Appl. No.: 19/234,281

(22) Filed: Jun. 11, 2025

(30) Foreign Application Priority Data
Jun. 11, 2024 (CN) 2024107422046

(51) Int. Cl. H02J 3/12; H02J 3/38

(52) U.S. Cl. CPC H02J 3/12; H02J 3/381; H02J 2203/20; H02J 2300/20

(57) ABSTRACT

The present disclose provides a model-free adaptive dynamic voltage control method considering multi-inverter coordination, relates to a technology field of power system operation. The method includes: constructing a data-driven dynamic linearization model for dynamic voltage control of a new energy cluster; acquiring online measurement data through a measurement apparatus of the new energy cluster, and updating the data-driven dynamic linearization model in real time based on the online measurement data through a block update recursive least squares method; and generating, based on the data-driven dynamic linearization model updated in real time, a dynamic coordination control instruction for a coordination controller of the new energy cluster in an iterative form, and performing adaptive dynamic voltage control based on the dynamic coordination control instruction generated iteratively. With the technical solution of the present disclosure, adaptive dynamic voltage control on the power system is realized.

### CROSS-REFERENCE TO RELATED PATENT APPLICATION

The present application is based on and claims the priority of Chinese patent application No. 2024107422046 filed on Jun. 11, 2024, the entire contents of which are incorporated herein by reference.

### FIELD OF THE DISCLOSURE

The present disclosure relates to the technical field of power system operation, and in particular to a model-free adaptive dynamic voltage control method considering multi-inverter coordination, and a model-free adaptive dynamic voltage control system considering multi-inverter coordination.

### BACKGROUND OF THE DISCLOSURE

Under driven by energy and environmental issues, the proportion of renewable energy such as photovoltaic power generation in a power grid is increasing, and large-scale, high-penetration renewable energy grid-connected power generation has become a frontier and hot topic in the international energy and power field. Due to intermittency and volatility of renewable energy power generation, its increased penetration has brought severe challenges to operation and control of the power grid, especially a serious grid overvoltage problem. Considering the sudden overvoltage problem that may occur in the power grid, dynamic voltage support is an important auxiliary service in the power grid, and the lack of dynamic voltage support may cause a serious system safety problem. Further, renewable energy is usually connected to the power grid through power electronic inverters, and these inverters have a capability to provide fast, dynamic and continuous reactive power support, which can be used for grid voltage control. Therefore, in order to give full play to a reactive power regulation capability of the inverter and improve a voltage quality of the power grid with high-penetration renewable energy, it is necessary to use the inverter for dynamic voltage control.

Traditional dynamic reactive power voltage control methods of the inverters often only consider the control of a single inverter, but do not consider coordination among multiple inverters. However, the large-scale penetration of renewable energy has formed many renewable energy clusters in the power grid, such as new energy industrial parks, photovoltaic power plants, etc. There are multiple inverters in a renewable energy cluster, and coordination among the multiple inverters needs to realize. A traditional single-inverter dynamic voltage control method only considers the problem that a single inverter dynamically adjusts its own reactive power output to enable the voltage at the single-inverter grid-connected point to track its voltage reference value. On the one hand, for a new energy inverter with small capacity, a single inverter is often not enough to provide sufficient voltage support for the power grid, and a sufficient voltage support capability can be provided to the power grid only by forming a cluster with multiple inverters; on the other hand, for a new energy cluster containing multiple inverters, a primary goal should be to dynamically control the voltage at a grid-connected point of the cluster to track a voltage reference value, which requires dynamic coordination between multiple inverters in the cluster. The existing single-inverter dynamic control method cannot solve such a coordination control problem.

Moreover, most traditional voltage control methods rely on accurate system model parameters, while an ideal model of the power grid is difficult to obtain, which makes these traditional model-based methods difficult to apply. In addition, since the topology structure, load power, renewable energy power generation output and other operating conditions of the actual power grid will change frequently, the dynamic voltage control method of the power grid also needs to consider adaptability of the control method to system changes.

### SUMMARY OF THE DISCLOSURE

The present disclosure aims to solve one of technical problems in the related art at least to some extent.

Accordingly, a first objective of the present disclosure is to provide a model-free adaptive dynamic voltage control method considering multi-inverter coordination.

A second objective of the present disclosure is to provide a computer device.

A third objective of the present disclosure is to provide a non-transitory computer-readable storage medium.

In order to achieve the above objectives, a first aspect of embodiments of the present disclosure provides a model-free adaptive dynamic voltage control method considering multi-inverter coordination. The method includes: constructing a data-driven dynamic linearization model for dynamic voltage control of a new energy cluster; acquiring online measurement data through a measurement apparatus of the new energy cluster, and updating the data-driven dynamic linearization model in real time based on the online measurement data through a block update recursive least squares method; and generating, based on the data-driven dynamic linearization model updated in real time, a dynamic coordination control instruction for a coordination controller of the new energy cluster in an iterative form, and performing adaptive dynamic voltage control based on the dynamic coordination control instruction generated iteratively.

In order to achieve the above objectives, a second aspect of embodiments of the present disclosure provides a computer device, including a memory, a processor and a computer program stored on the memory and excitable on the processor. When the processor executes the computer program, the model-free adaptive dynamic voltage control method considering multi-inverter coordination as described above is implemented.

In order to achieve the above objectives, a third aspect of embodiments of the present disclosure provides a non-transitory computer-readable storage medium having a computer program stored thereon. When the computer program is executed on a computer, the computer is caused to perform the model-free adaptive dynamic voltage control method considering multi-inverter coordination as described above.

Additional aspects and advantages of the present disclosure will be given in part in the description below, and will become apparent from the description below, or will be learned through the practice of the present disclosure.

### BRIEF DESCRIPTION OF THE DRAWINGS

The above and/or additional aspects and advantages of the present disclosure will become apparent and easily understood from the following description of the embodiments in conjunction with the accompanying drawings, in which:

FIG. 1 is a schematic flowchart of a model-free adaptive dynamic voltage control method considering multi-inverter coordination according to an embodiment of the present disclosure;

FIG. 2 is a block diagram of a model-free adaptive dynamic voltage control system considering multi-inverter coordination according to an embodiment of the present disclosure.

### DETAILED DESCRIPTION OF THE EXEMPLARY EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

A model-free adaptive dynamic voltage control method considering multi-inverter coordination and a model-free adaptive dynamic voltage control system considering multi-inverter coordination according to embodiments of the present disclosure will be described below with reference to the accompanying drawings.

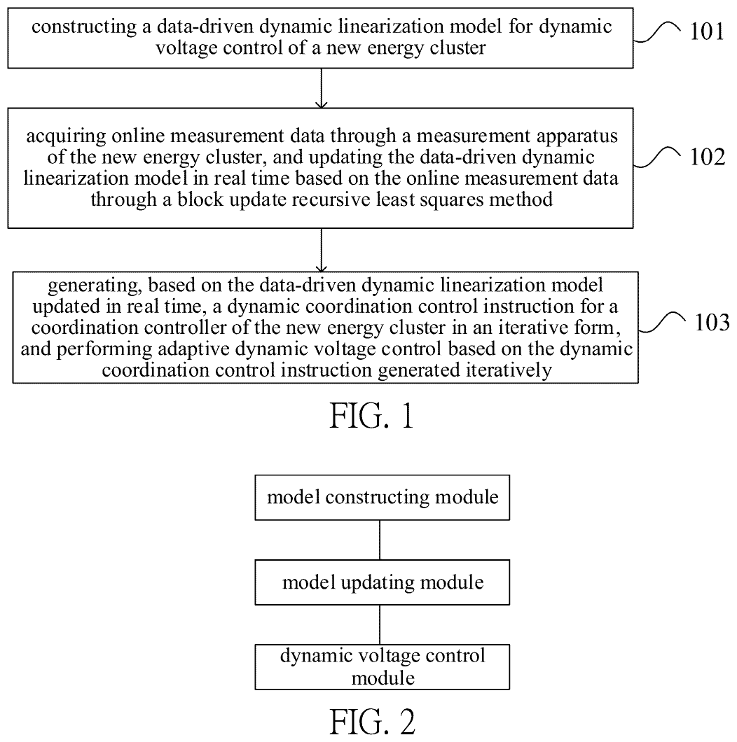

FIG. 1 is a schematic flowchart of a model-free adaptive dynamic voltage control method considering multi-inverter coordination according to an embodiment of the present disclosure.

As shown in FIG. 1, the model-free adaptive dynamic voltage control method considering multi-inverter coordination includes the following steps.

At step 101, a data-driven dynamic linearization model for dynamic voltage control of a new energy cluster is constructed.

At step 102, online measurement data is acquired through a measurement apparatus of the new energy cluster, and the data-driven dynamic linearization model is updated in real time based on the online measurement data through a block update recursive least squares method.

At step 103, based on the data-driven dynamic linearization model updated in real time, a dynamic coordination control instruction for a coordination controller of the new energy cluster is generated in an iterative form, and adaptive dynamic voltage control is performed based on the dynamic coordination control instruction generated iteratively. The dynamic coordination control instruction is sent by the coordination controller to each inverter of the new energy cluster, so that each inverter adjusts its local voltage to a voltage reference instruction value according to the dynamic coordination control instruction.

With the model-free adaptive dynamic voltage control method considering multi-inverter coordination according to the embodiments of the present disclosure, firstly a dynamic linearization model for a cluster system that considers the coordination of multiple inverters to improve voltage support is constructed; then, in a real-time control process, the coordination controller in the new energy cluster continuously collects real-time measurement data of the system and updates the data-driven dynamic linearization model in real time based on the block update recursive least squares method, further the coordination controller in the new energy cluster, based on the real-time updated data-driven dynamic linearization model, iteratively updates the adaptive control instruction and sends the adaptive control instruction to a local controller of each inverter in the cluster. Finally, the model-free adaptive dynamic voltage control of the new energy cluster considering the multi-inverter coordination is realized, so that the grid-connected point of the new energy cluster may dynamically track its voltage reference value.

With the embodiments of the present disclosure, dynamic control of multi-inverter coordination in the new energy cluster may be realized, so that a voltage at a grid-connected point of the new energy cluster may dynamically track its reference value. Meanwhile, by using the block update recursive least squares method to online estimate the dynamic linearization model for the cluster, adaptive update of control parameters may be implemented with the real-time measurement data of the system, independent of precise system model parameters.

The embodiments of the present disclosure have greatly improved the efficiency, safety, and flexibility of the dynamic voltage control method for the power grid in scenarios with incomplete models and high-penetration new energy, which are particularly suitable for use in the power grid with missing model parameters and serious voltage dynamic fluctuation problems. Dynamic coordination control of multiple inverters within the new energy cluster in the power grid may be implemented, to dynamically adjust the voltage at the grid-connected point of the new energy cluster in the power grid to track its voltage reference value. Further, the present disclosure has adaptability to changes in system operating conditions, which is suitable for large-scale promotion.

Optionally, according to an embodiment of the present disclosure, for the dynamic voltage control of the new energy cluster having n controllable inverters, the data-driven dynamic linearization model is expressed as:

$$Δ y ( k + 1 ) = {Θ}_{k}^{T} Δ \overline{u} ( k ) ;$$

where, Θₖ represents an equivalent dynamic parameter vector at a k-th control moment, Θₖ is an n-dimensional column vector,

$${Θ}_{k}^{T}$$

is a transpose of Θₖ,

$${Θ}_{k}^{T}$$

is an n-dimensional row vector, Δy(k+1) represents a system output increment at a (k+1)-th control moment, Δy(k+1) is a scalar, Δū(k) represents a system control input increment at the k-th control moment, Δū(k) is an n-dimensional column vector,

$$Δ y ( k + 1 ) = y ( k + 1 ) - y ( k ) \\ Δ \overline{u} ( k ) = \overline{u} ( k ) - {V}_{PVs} ( k )$$

where, y(k+1) represents a voltage at a grid-connected point of the new energy cluster at the (k+1)-th control moment, y(k) represents a voltage at the grid-connected point of the new energy cluster at the k-th control moment, both y(k+1) and y(k) are scalars, ū(k) represents a reference control instruction for local voltages of all inverters in the new energy cluster at the k-th control moment, i.e., indicating voltage reference instruction values for all the inverters, V_{PVs}(k) represents actual measured values of the local voltages of all inverters in the new energy cluster at the k-th control moment, and both ū(k) and V_{PVs}(k) are n-dimensional column vectors.

Optionally, according to an embodiment of the present disclosure, updating the data-driven dynamic linearization model in real time based on the online measurement data through a block update recursive least squares method comprises the following steps.

A measurement signal is acquired from the measurement apparatus of the new energy cluster to obtain Nₖ latest groups of online measurement data (Uₖ,Yₖ), where Uₖ is a matrix containing system input measurement data for the new energy cluster of Nₖ data samples,

$${U}_{k} = [ Δ {u ( {t}_{1}^{k} )}^{T} , Δ {u ( {t}_{2}^{k} )}^{T} , Δ {u ( {t}_{3}^{k} )}^{T} , … , Δ {u ( {t}_{{N}_{k - 1}}^{k} )}^{T} , Δ {u ( {t}_{{N}_{k}}^{k} )}^{T} ] ,$$

Yₖ is a vector containing output measurement data of Nₖ data samples,

$${Y}_{k} = {[ Δ y ( {t}_{1}^{k} ) , Δ y ( {t}_{2}^{k} ) , Δ y ( {t}_{3}^{k} ) , … , Δ y ( {t}_{{N}_{k - 1}}^{k} ) , Δ y ( {t}_{{N}_{k}}^{k} ) ]}^{T} ,$$

T represents a transposition operation of a matrix or vector.

Uₖ is a matrix with Nₖ rows and n columns, containing measured values

$$Δ {u ( {t}_{1}^{k} )}^{T} , Δ {u ( {t}_{2}^{k} )}^{T} , Δ {u ( {t}_{3}^{k} )}^{T} , … , Δ {u ( {t}_{{N}_{k} - 1}^{k} )}^{T} , Δ {u ( {t}_{{N}_{k}}^{k} )}^{T}$$

of voltage changes in the local voltages of all inverters in the new energy cluster at Nₖ sampling moments

$${t}_{1}^{k} , {t}_{2}^{k} , {t}_{3}^{k} , … , {t}_{{N}_{k} - 1}^{k} , {t}_{{N}_{k}}^{k} .$$

In detail, a voltage change in the local voltage of an inverter at a sampling moment equals a voltage value at the sampling moment minus a voltage value at a previous sampling moment. Yₖ is an Nₖ-dimensional column vector, containing measured values

$$Δ y ( {t}_{1}^{k} ) , Δ y ( {t}_{2}^{k} ) , Δ y ( {t}_{3}^{k} ) , … , Δ y ( {t}_{{N}_{k} - 1}^{k} ) , Δ y ( {t}_{{N}_{k}}^{k} )$$

of voltage changes at the grid-connected point of the new energy cluster at Nₖ sampling moments

$${t}_{1}^{k} , {t}_{2}^{k} , {t}_{3}^{k} , … , {t}_{{N}_{k} - 1}^{k} , {t}_{{N}_{k}}^{k} .$$

In detail, a voltage change at the grid-connected point of the new energy cluster at a sampling moment equals a voltage value at the sampling moment minus a voltage value at a previous sampling moment.

It should be noted that elements in the data matrix Uₖ and the data vector Yₖ are data measured between the (k−1)-th control moment and the k-th control moment. Since the sampling time interval of these data may be less than a control time interval that the coordination controller updates the control instruction, Nₖ data samples may be collected between the (k−1)-th control moment and the k-th control moment, and the number of data samples Nₖ≥1.

Based on the online measurement data and according to the block update recursive least squares method, the equivalent dynamic parameter vector of the data-driven dynamic linearization model is calculated to implement online real-time update of the data-driven dynamic linearization model.

Optionally, according to an embodiment of the present disclosure, the equivalent dynamic parameter vector Θₖ at the k-th control moment is calculated according to the block update recursive least squares method by the following steps, to implement online update of the data-driven dynamic linearization model:
a) determining a size relationship between Nₖ and n, in case of Nₖ≥ n, executing step b), or else, executing step c);
b) performing calculations according to the following formulas:

$${K}_{k} = {β}^{{N}_{k}} {K}_{k - 1} + {U}_{k}^{T} {B}_{k} {U}_{k} \\ {Θ}_{k} = {Θ}_{k - 1} + {K}_{k}^{- 1} {U}_{k}^{T} {B}_{k} ( {Y}_{k} - {U}_{k} {Θ}_{k - 1} )$$

where, Kₖ represents an information matrix at the k-th control moment, β^{N}^{ₖ} represents the Nₖ-th power of a forgetting factor β,

$${U}_{k}^{T}$$

is a transpose of the matrix Uₖ, Bₖ is an Nₖ-dimensional diagonal matrix, elements of which are composed of powers of the forgetting factor β, Bₖ=diag(β^{N}^{ₖ₋₁}, . . . ,1), i.e., non-diagonal elements in the matrix Bₖ are all 0, while Nₖ diagonal elements from the upper left corner to lower right corner are β^{N}^{ₖ₋₁},β^{N}^{ₖ₋₂}, . . . ,β₂,β, 1, and Θₖ is the equivalent dynamic parameter vector at the k-th control moment;
c) performing calculations according to the following formulas:

$${P}_{k} = \frac{{P}_{k - 1}}{{β}^{{N}_{k}}} - \frac{{P}_{k - 1}}{{β}^{{N}_{k}}} {U}_{k}^{T} ( {B}_{P k} + {U}_{k} {P}_{k - 1} {U}_{k}^{T} ) {U}_{k} {P}_{k - 1} \\ {Θ}_{k} = {Θ}_{k - 1} + {P}_{k} {U}_{k}^{T} {B}_{k} ( {Y}_{k} - {U}_{k} {Θ}_{k - 1} )$$

where, Pₖ represents an inverse information matrix at the k-th control moment, B_{Pk} is an Nₖ-dimensional diagonal matrix, elements of which are composed of powers of the forgetting factor β, B_{Pk}=diag(β,β²,β³, . . . ,β^{N}^{ₖ}), i.e., non-diagonal elements in the matrix B_{Pk} are all 0, while Nₖ diagonal elements from the upper left corner to lower right corner are β,β²,β³, . . . ,β^{N}^{ₖ₋₁},β^{N}^{ₖ}, the superscript-1 indicates the inverse operation of the matrix.

Optionally, according to an embodiment of the present disclosure, before updating the data-driven dynamic linearization model, the method further includes the following steps.

N₀ groups of initialization training data (U₀,Y₀) are acquired.

U₀ is a matrix containing system input measurement data for the new energy cluster of N₀ data samples,

$${U}_{0} = [ Δ {u ( {t}_{1}^{0} )}^{T} , Δ {u ( {t}_{2}^{0} )}^{T} , Δ {u ( {t}_{3}^{0} )}^{T} , … , Δ {u ( {t}_{{N}_{0} - 1}^{0} )}^{T} , Δ {u ( {t}_{{N}_{0}}^{0} )}^{T} ] ,$$

Y₀ is a vector containing output measurement data of N₀ data samples,

$${Y}_{0} = {[ Δ y ( {t}_{1}^{0} ) , Δ y ( {t}_{2}^{0} ) , Δ y ( {t}_{3}^{0} ) , … , Δ y ( {t}_{{N}_{0} - 1}^{0} ) , Δ y ( {t}_{{N}_{0}}^{0} ) ]}^{T} ,$$

T represents a transposition operation of a matrix or vector.

U₀ is a matrix with N₀ rows and n columns, containing measured values

$$Δ {u ( {t}_{1}^{0} )}^{T} , Δ {u ( {t}_{2}^{0} )}^{T} , Δ {u ( {t}_{3}^{0} )}^{T} , … , Δ {u ( {t}_{{N}_{0} - 1}^{0} )}^{T} , Δ {u ( {t}_{{N}_{0}}^{0} )}^{T}$$

of voltage changes in the local voltages of all inverters in the new energy cluster at N₀ sampling moments

$${t}_{1}^{0} , {t}_{2}^{0} , {t}_{3}^{0} , … , {t}_{{N}_{0} - 1}^{0} , {t}_{{N}_{0}}^{0} .$$

In detail, a voltage change in the local voltage of an inverter at a sampling moment equals a voltage value at the sampling moment minus a voltage value at a previous sampling moment. Y₀ is an N₀-dimensional column vector, containing measured values

$$Δ y ( {t}_{1}^{0} ) , Δ y ( {t}_{2}^{0} ) , Δ y ( {t}_{3}^{0} ) , … , Δ y ( {t}_{{N}_{0} - 1}^{0} ) , Δ y ( {t}_{{N}_{0}}^{0} )$$

of voltage changes at the grid-connected point of the new energy cluster at N₀ sampling moments

$${t}_{1}^{0} , {t}_{2}^{0} , {t}_{3}^{0} , … , {t}_{{N}_{0} - 1}^{0} , {t}_{{N}_{0}}^{0} .$$

In detail, a voltage change at the grid-connected point of the new energy cluster at a sampling moment equals a voltage value at the sampling moment minus a voltage value at a previous sampling moment.

Initialization is performed on control parameters in the data-driven dynamic linearization model and the block-update recursive least squares method based on the initialization training data, in which the control parameter of the data-driven dynamic linearization model includes the equivalent dynamic parameter vector, and the control parameters in the block-update recursive least squares method include the information matrix, and the inverse information matrix.

First, a value of the forgetting factor β in the block-update recursive least squares method is selected. A value range of β is (0, 1], and a typical value is 0.9.

Then, an initial value K₀ of the information matrix in the block-update recursive least squares method is calculated by the following formula:

$${K}_{0} = {U}_{0}^{T} {B}_{0} {U}_{0} + α {I}_{n}$$

where

$${U}_{0}^{T}$$

is a transpose of the matrix U₀, α is a scalar which has a relatively small value greater than 0, the typical value is 10⁻³, Iₙ is an n-dimensional identity matrix, B₀ is an N₀-dimensional diagonal matrix, elements of which are composed of powers of the forgetting factor β, B₀=diag(B^{N}^{₀₋₁}, . . . ,1), i.e., non-diagonal elements in the matrix B₀ are all 0, while N₀ diagonal elements from the upper left corner to lower right corner are β^{N}^{₀₋₁},β^{N}^{₀₋₂}, . . . ,β²,β,1.

After the matrix K₀ is obtained, an initial value P₀ of the inverse information matrix in the block-update recursive least squares method is calculated by the following formula:

$${P}_{0} = {K}_{0}^{- 1}$$

where

$${K}_{0}^{- 1}$$

represents an inverse matrix of the matrix K₀.

According to a ridge regression algorithm, an initial value Θ₀ of the equivalent dynamic parameter vector is calculated by the following formula:

$${Θ}_{0} = {P}_{0} {U}_{0}^{T} {B}_{0} {Y}_{0}$$

Optionally, according to an embodiment of the present disclosure, generating, based on the data-driven dynamic linearization model updated at a current control moment, a dynamic coordination control instruction for the coordination controller of the new energy cluster at the current control moment, includes:

acquiring online measurement data at the current control moment k through the measurement apparatus of the new energy cluster, in which the online measurement data at the current control moment k includes measured values V_{PVs}(k) of the local voltages of all controllable inverters in the new energy cluster at the current control moment k and a measured value y(k) of the voltage at the grid-connected point of the new energy cluster at the current control moment; and
generating a control instruction at the current control moment based on the online measurement data at the current control moment k and the data-driven dynamic linearization model updated at the current control moment k.

Performing adaptive dynamic voltage control based on the dynamic coordination control instruction for the coordination controller of the new energy cluster at the current control moment, includes:
sending, by the coordination controller of the new energy cluster, the control instruction ū(k) to all controllable inverters in the new energy cluster, so that all the controllable inverters in the new energy cluster performs control according to the control instruction to adjust the local voltages to corresponding voltage reference instruction values, thereby realizing the adaptive dynamic voltage control of the new energy cluster and enabling that the voltage at the grid-connected point of the new energy cluster tracks its voltage reference value.

Optionally, according to an embodiment of the present disclosure, the control instruction at the current control moment is expressed as:

$$\overline{u} ( k ) = {V}_{PVs} ( k ) + \frac{{ρ}_{CC} {Θ}_{k} ( {y}^{*} ( k ) - y ( k ) )}{{λ}_{CC} + {‖ k ‖}^{2}}$$

where ū(k) is the reference control instruction for the local voltages of all inverters in the new energy cluster calculated at the k-th control moment, λ_{CC} is a suppression factor which is a positive scalar, the typical value may be 10⁻³, ρ_{CC} is a control update step size which is a positive scalar, the typical value may be 1.0, y*(k) is a reference value of the voltage at the grid-connected point of the new energy cluster at the k-th control moment, ∥Θₖ∥² represents the 2-norm of Θₖ, and Θₖ represents the equivalent dynamic parameter vector at the k-th control moment.

Optionally, according to an embodiment of the present disclosure, let k=k+1, and the following steps are performed again:
acquiring online measurement data through a measurement apparatus of the new energy cluster, and updating the data-driven dynamic linearization model in real time based on the online measurement data through the block update recursive least squares method; and
generating, based on the data-driven dynamic linearization model updated in real time, the dynamic coordination control instruction for the coordination controller of the new energy cluster in an iterative form, and performing adaptive dynamic voltage control based on the dynamic coordination control instruction generated iteratively.

In order to achieve the above objectives, the present disclosure further provides a model-free adaptive dynamic voltage control system considering multi-inverter coordination.

As shown in FIG. 2, the model-free adaptive dynamic voltage control system considering multi-inverter coordination includes:
a model constructing module, configured to construct a data-driven dynamic linearization model for dynamic voltage control of a new energy cluster;
a model updating module, configured to acquire online measurement data through a measurement apparatus of the new energy cluster, and update the data-driven dynamic linearization model in real time based on the online measurement data through a block update recursive least squares method; and
a dynamic voltage control module, configured to generate, based on the data-driven dynamic linearization model updated in real time, a dynamic coordination control instruction for a coordination controller of the new energy cluster in an iterative form, and perform adaptive dynamic voltage control based on the dynamic coordination control instruction generated iteratively.

Optionally, according to an embodiment of the present disclosure, for the dynamic voltage control of the new energy cluster having n controllable inverters, the data-driven dynamic linearization model is expressed as:

$$Δ y ( k + 1 ) = {Θ}_{k}^{T} Δ \overline{u} ( k )$$

where, Θₖ represents an equivalent dynamic parameter vector at a k-th control moment, Θₖ is an n-dimensional column vector,

$${Θ}_{k}^{T}$$

is a transpose of Θₖ, Δy(k+1) represents a system output increment at a (k+1)-th control moment, Δy(k+1) is a scalar, Δū(k) represents a system control input increment at the k-th control moment, Δū(k) is an n-dimensional column vector,

$$Δ y ( k + 1 ) = y ( k + 1 ) - y ( k ) \\ Δ \overline{u} ( k ) = \overline{u} ( k ) - {V}_{PVs} ( k )$$

where, y(k+1) represents a voltage at a grid-connected point of the new energy cluster at the (k+1)-th control moment, y(k) represents a voltage at a grid-connected point of the new energy cluster at the k-th control moment, ū(k) represents a reference control instruction for local voltages of all inverters in the new energy cluster at the k-th control moment, ū(k) is an n-dimensional column vector, V_{PVs}(k) represents actual measured values of the local voltages of all inverters in the new energy cluster at the k-th control moment, and V_{PVs}(k) is an n-dimensional column vector.

It should be noted that the above explanation of the embodiment of the model-free adaptive dynamic voltage control method considering multi-inverter coordination is also applicable to the model-free adaptive dynamic voltage control system considering multi-inverter coordination of this embodiment, which will not be repeated here.

In order to achieve the above objectives, the present disclosure provides a computer device, including a memory, a processor and a computer program stored on the memory and excitable on the processor. When the processor executes the computer program, the model-free adaptive dynamic voltage control method considering multi-inverter coordination as described above is implemented.

In order to achieve the above objectives, a third aspect of embodiments of the present disclosure provides a non-transitory computer-readable storage medium having a computer program stored thereon. When the computer program is executed on a computer, the computer is caused to perform the model-free adaptive dynamic voltage control method considering multi-inverter coordination as described above.

In the foregoing description of various embodiments, references to terms such as “an embodiment”, “some embodiments”, “example”, “specific example” or “some examples” indicate that specific features, structures, materials, or characteristics described in conjunction with the embodiment or example are included in at least one embodiment or example of the present disclosure. In this specification, the illustrative use of these terms does not necessarily refer to the same embodiment or example. Moreover, the specific features, structures, materials, or characteristics described may be combined in any suitable manner in one or more embodiments or examples. Furthermore, without contradiction, those skilled in the art may combine and integrate different embodiments or examples described in this specification, as well as the features of different embodiments or examples.

In addition, the terms “first” and “second” are used only for descriptive purposes and should not be interpreted as indicating or implying relative importance or implicitly specifying the number of technical features indicated. Therefore, features limited by “first” or “second” can explicitly or implicitly include at least one such feature. In the description of the present disclosure, the term “multiple” means at least two, such as two, three, etc., unless otherwise specifically defined.

The description of any process or method depicted in the flowchart or otherwise herein can be understood as representing a module, fragment, or part of code that includes one or more executable instructions for implementing custom logic functions or processes. The preferred embodiments of the present disclosure include additional implementations, where functions can be performed in a substantially simultaneous manner or in reverse order according to the involved functionalities, without necessarily following the sequence shown or discussed. This should be understood by those skilled in the art to which the embodiments of the present disclosure belong.

The logic and/or steps represented in the flowchart or described herein can be considered as a sequence of executable instructions for implementing logical functions. These can be embodied in any computer-readable medium for use by an instruction execution system, device, or apparatus (such as a computer-based system, a system including a processor, or other systems that can take and execute instructions from an instruction execution system, device, or apparatus), or in conjunction with these instruction execution systems, devices, or apparatuses. For the purposes of this specification, “computer-readable medium” can refer to any device that contains, stores, communicates, transmits, or otherwise delivers programs for use by an instruction execution system, device, or apparatus, or in conjunction with such systems, devices, or apparatuses. More specific examples of computer-readable media (not exhaustive list) include: electrical connection parts with one or more wiring (electronic devices), portable computer disk drives (magnetic devices), random access memory (RAM), read-only memory (ROM), erasable programmable read-only memory (EPROM or flash memory), optical fiber devices, and portable optical disc read-only memory (CD-ROM). Additionally, computer-readable media can even be paper or other suitable media on which the program can be printed, as the program can be obtained electronically by, for example, optical scanning of paper or other media, followed by editing, interpretation, or processing as necessary in other appropriate ways, and then stored in a computer memory.

It should be understood that various parts of the present disclosure can be implemented using hardware, software, firmware, or combinations thereof. In the aforementioned embodiments, multiple steps or methods can be realized through software or firmware stored in memory and executed by a suitable instruction execution system. For example, if implemented using hardware, as in another embodiment, any one or combination of the following techniques known to those skilled in the art can be used: discrete logic circuits with logic gate circuits for implementing logical functions on data signals, application-specific integrated circuits with appropriate combinational logic gate circuits, programmable gate arrays (PGAs), field-programmable gate arrays (FPGAs), etc.

A person skilled in the art of this technical field can understand that all or part of the steps carried by the above embodiments can be completed by instructing the related hardware through a program, and the program can be stored in a computer-readable storage medium, which includes one or a combination of the steps of the embodiment when executed.

In addition, in various embodiments of the present disclosure, each functional unit can be integrated into a processing module, or each unit can exist physically separately, or two or more units can be integrated into one module. The integrated modules can be implemented either in hardware form or as software function modules. If the integrated modules are implemented as software function modules and sold or used as independent products, they can also be stored on a computer-readable storage medium.

The storage medium mentioned above may be a read-only memory, a magnetic disk or an optical disk, etc. Although the embodiments of the present disclosure have been shown and described above, it can be understood that the above embodiments are exemplary and cannot be understood as limiting the present disclosure. A person of ordinary skill in the art may change, modify, replace and modify the above embodiments within the scope of the present disclosure.

What is claimed is:

1. A model-free adaptive dynamic voltage control method considering multi-inverter coordination, comprising:
constructing a data-driven dynamic linearization model for dynamic voltage control of a new energy cluster;
acquiring online measurement data through a measurement apparatus of the new energy cluster, and updating the data-driven dynamic linearization model in real time based on the online measurement data through a block update recursive least squares method; and
generating, based on the data-driven dynamic linearization model updated in real time, a dynamic coordination control instruction for a coordination controller of the new energy cluster in an iterative form, and performing adaptive dynamic voltage control based on the dynamic coordination control instruction generated iteratively.

2. The method according to claim 1, wherein for the dynamic voltage control of the new energy cluster having n controllable inverters, the data-driven dynamic linearization model is expressed as:
$$Δ y ( k + 1 ) = {Θ}_{k}^{T} Δ \overline{u} ( k )$$
where, Θₖ represents an equivalent dynamic parameter vector at a k-th control moment, Θₖ is an n-dimensional column vector,
$${Θ}_{k}^{T}$$
is a transpose of Θₖ, Δy(k+1) represents a system output increment at a (k+1)-th control moment, Δy(k+1) is a scalar, Δū(k) represents a system control input increment at the k-th control moment, Δū(k) is an n-dimensional column vector, k is an integer greater than or equal to 0;
$$Δ y ( k + 1 ) = y ( k + 1 ) - y ( k ) \\ Δ \overline{u} ( k ) = \overline{u} ( k ) - {V}_{PVs} ( k )$$
where, y(k+1) represents a voltage at a grid-connected point of the new energy cluster at the (k+1)-th control moment, y(k) represents a voltage at the grid-connected point of the new energy cluster at the k-th control moment, ū(k) represents a reference control instruction for local voltages of all controllable inverters in the new energy cluster at the k-th control moment, ū(k) is an n-dimensional column vector, V_{PVs}(k) represents actual measured values of the local voltages of all controllable inverters in the new energy cluster at the k-th control moment, and V_{PVs}(k) is an n-dimensional column vector.

3. The method according to claim 2, wherein updating the data-driven dynamic linearization model in real time based on the online measurement data through a block update recursive least squares method comprises:
acquiring a measurement signal from the measurement apparatus of the new energy cluster to obtain Nₖ latest groups of online measurement data (Uₖ,Yₖ), where Uₖ is a data matrix with Nₖ rows and n columns,
$${U}_{k} = [ Δ {u ( {t}_{1}^{k} )}^{T} , Δ {u ( {t}_{2}^{k} )}^{T} , Δ {u ( {t}_{3}^{k} )}^{T} , … , Δ {u ( {t}_{{N}_{k - 1}}^{k} )}^{T} , Δ {u ( {t}_{{N}_{k}}^{k} )}^{T} ] , Δ {u ( {t}_{{N}_{k}}^{k} )}^{T}$$
is a vector indicating a difference between local voltages of each controllable inverter at an Nₖ-th sampling moment and an Nₖ₋₁-th sampling moment, Yₖ is an Nₖ-dimensional column vector,
$${Y}_{k} = {[ Δ y ( {t}_{1}^{k} ) , Δ y ( {t}_{2}^{k} ) , Δ y ( {t}_{3}^{k} ) , … , Δ y ( {t}_{{N}_{k - 1}}^{k} ) , Δ y ( {t}_{{N}_{k}}^{k} ) ]}^{T} , Δ y ( {t}_{{N}_{k}}^{k} )$$
is a measured value of a voltage change at the grid-connected point of the new energy cluster at the Nₖ-th sampling moment, T represents a transposition operation,
$${t}_{1}^{k} , {t}_{2}^{k} , {t}_{3}^{k} , … , {t}_{{N}_{k} - 1}^{k} , {t}_{{N}_{k}}^{k}$$
represent Nₖ sampling moments, elements in the data matrix Uₖ and the vector Yₖ are data measured between the (k−1)-th control moment and the k-th control moment, Nₖ≥1; and
calculating, based on the online measurement data and according to the block update recursive least squares method, the equivalent dynamic parameter vector of the data-driven dynamic linearization model to implement online real-time update of the data-driven dynamic linearization model.

4. The method according to claim 3, wherein the online real-time update comprises:
determining a size relationship between Nₖ and n, in case of Nₖ≥ n, performing calculation based on a first update formula, and in case of Nₖ<n, performing calculation based on a second update formula;
wherein the first update formula is expressed as:
$${K}_{k} = {β}^{{N}_{k}} {K}_{k - 1} + {U}_{k}^{T} {B}_{k} {U}_{k} \\ {Θ}_{k} = {Θ}_{k - 1} + {K}_{k}^{- 1} {U}_{k}^{T} {B}_{k} ( {Y}_{k} - {U}_{k} {Θ}_{k - 1} )$$
where, Kₖ represents an information matrix at the k-th control moment, β^{N}^{ₖ} represents the Nₖ-th power of a forgetting factor β,
$${U}_{k}^{T}$$
is a transpose of the matrix Uₖ, Bₖ is an Nₖ-dimensional diagonal matrix, elements of which are composed of powers of the forgetting factor β,
$${B}_{k} = diag ( {β}^{{N}_{k - 1}} , … , 1 ) , {K}_{k}^{- 1}$$
represents an inverse matrix of the information matrix Kₖ;
wherein the second update formula is expressed as:
$${P}_{k} = \frac{{P}_{k - 1}}{{β}^{{N}_{k}}} - \frac{{P}_{k - 1}}{{β}^{{N}_{k}}} {U}_{k}^{T} ( {B}_{P k} + {U}_{k} {P}_{k - 1} {U}_{k}^{T} ) {U}_{k} {P}_{k - 1} \\ {Θ}_{k} = {Θ}_{k - 1} + {P}_{k} {U}_{k}^{T} {B}_{k} ( {Y}_{k} - {U}_{k} {Θ}_{k - 1} )$$
where, Pₖ represents an inverse information matrix at the k-th control moment, B_{Pk} is an Nₖ-dimensional diagonal matrix, elements of which are composed of powers of the forgetting factor β, B_{Pk}=diag(β,β²,β³, . . . ,β^{N}^{ₖ}).

5. The method according to claim 4, wherein, before updating the data-driven dynamic linearization model, the method further comprises:
acquiring N₀ groups of initialization training data (U₀,Y₀); and
performing initialization on control parameters of the data-driven dynamic linearization model and the block-update recursive least squares method based on the initialization training data, wherein the control parameter of the data-driven dynamic linearization model comprises the equivalent dynamic parameter vector, and the control parameters of the block-update recursive least squares method comprise the forgetting factor, the information matrix, and the inverse information matrix;
wherein an initial value of the forgetting factor β is a preset value;
an initial value of the information matrix is:
$${K}_{0} = {U}_{0}^{T} {B}_{0} {U}_{0} + α {I}_{n}$$
where
$${U}_{0}^{T}$$
is a transpose of the matrix U₀, B₀ is an N₀-dimensional diagonal matrix, elements of which are composed of powers of the forgetting factor β, B₀=diag(β^{N}^{₀₋₁}, . . . ,1), Iₙ is an n-dimensional identity matrix, and α is a scalar greater than zero;
an initial value of the inverse information matrix is:
$${P}_{0} = {K}_{0}^{- 1}$$
where
$${K}_{0}^{- 1}$$
represents an inverse matrix of the matrix K₀;
an initial value of the equivalent dynamic parameter vector is:
$${Θ}_{0} = {P}_{0} {U}_{0}^{T} {B}_{0} {Y}_{0} .$$

6. The method according to claim 4, wherein generating, based on the data-driven dynamic linearization model updated in real time, a dynamic coordination control instruction for a coordination controller of the new energy cluster in an iterative form, and performing adaptive dynamic voltage control based on the dynamic coordination control instruction generated iteratively, comprises: for each control moment, generating, based on the data-driven dynamic linearization model updated at the control moment, a dynamic coordination control instruction for the coordination controller of the new energy cluster at the control moment, and performing adaptive dynamic voltage control based on the dynamic coordination control instruction for the coordination controller of the new energy cluster at the control moment;
wherein generating, based on the data-driven dynamic linearization model updated at the control moment, a dynamic coordination control instruction for the coordination controller of the new energy cluster at the control moment, comprises:
acquiring online measurement data at the control moment through the measurement apparatus of the new energy cluster, wherein the online measurement data at the control moment comprises measured values of the local voltages of all controllable inverters in the new energy cluster at the control moment and a measured value of the voltage at the grid-connected point of the new energy cluster at the control moment; and
generating the dynamic coordination control instruction for the coordination controller of the new energy cluster at the control moment based on the online measurement data at the control moment and the data-driven dynamic linearization model updated at the control moment;
wherein performing adaptive dynamic voltage control based on the dynamic coordination control instruction for the coordination controller of the new energy cluster at the control moment, comprises:
sending the dynamic coordination control instruction at the control moment to all controllable inverters in the new energy cluster through the coordination controller of the new energy cluster, to enable all the controllable inverters to perform control to adjust the local voltages to corresponding voltage reference instruction values.

7. The method according to claim 6, wherein the dynamic coordination control instruction at the control moment is expressed as:
$$\overline{u} ( k ) = {V}_{PVs} ( k ) + \frac{{ρ}_{CC} {Θ}_{k} ( {y}^{*} ( k ) - y ( k ) )}{{λ}_{CC} + {‖ k ‖}^{2}}$$
where λ_{CC} is a suppression factor which is a positive scalar, ρ_{CC} is a control update step size which is a positive scalar, y*(k) is a reference value of the voltage at the grid-connected point of the new energy cluster at the k-th control moment, ∥Θₖ∥² represents the 2-norm of Θₖ.

8. A computer device, comprising: a memory, a processor and a computer program stored on the memory and excitable on the processor; wherein, when the processor executes the computer program and is configured to perform:
constructing a data-driven dynamic linearization model for dynamic voltage control of a new energy cluster;
acquiring online measurement data through a measurement apparatus of the new energy cluster, and updating the data-driven dynamic linearization model in real time based on the online measurement data through a block update recursive least squares method; and
generating, based on the data-driven dynamic linearization model updated in real time, a dynamic coordination control instruction for a coordination controller of the new energy cluster in an iterative form, and performing adaptive dynamic voltage control based on the dynamic coordination control instruction generated iteratively.

9. The device according to claim 8, wherein for the dynamic voltage control of the new energy cluster having n controllable inverters, the data-driven dynamic linearization model is expressed as:
$$Δ y ( k + 1 ) = {Θ}_{k}^{T} Δ \overline{u} ( k )$$
where, Θₖ represents an equivalent dynamic parameter vector at a k-th control moment, Θₖ is an n-dimensional column vector,
$${Θ}_{k}^{T}$$
is a transpose of Θₖ, Δy(k+1) represents a system output increment at a (k+1)-th control moment, Δy(k+1) is a scalar, Δū(k) represents a system control input increment at the k-th control moment, Δū(k) is an n-dimensional column vector, k is an integer greater than or equal to 0;
$$Δ y ( k + 1 ) = y ( k + 1 ) - y ( k )$$
$$Δ \overline{u} ( k ) = \overline{u} ( k ) - {V}_{PVs} ( k )$$
where, y(k+1) represents a voltage at a grid-connected point of the new energy cluster at the (k+1)-th control moment, y(k) represents a voltage at the grid-connected point of the new energy cluster at the k-th control moment, ū(k) represents a reference control instruction for local voltages of all controllable inverters in the new energy cluster at the k-th control moment, ū(k) is an n-dimensional column vector, V_{PVs}(k) represents actual measured values of the local voltages of all controllable inverters in the new energy cluster at the k-th control moment, and V_{PVs}(k) is an n-dimensional column vector.

10. The device according to claim 9, wherein updating the data-driven dynamic linearization model in real time based on the online measurement data through a block update recursive least squares method comprises:
acquiring a measurement signal from the measurement apparatus of the new energy cluster to obtain Nₖ latest groups of online measurement data (Uₖ,Yₖ), where Uₖ is a data matrix with Nₖ rows and n columns,
$${U}_{k} = [ Δ {u ( {t}_{1}^{k} )}^{T} , Δ {u ( {t}_{2}^{k} )}^{T} , Δ {u ( {t}_{3}^{k} )}^{T} , … , Δ {u ( {t}_{{N}_{k - 1}}^{k} )}^{T} , Δ {u ( {t}_{{N}_{k}}^{k} )}^{T} ] , Δ {u ( {t}_{{N}_{k}}^{k} )}^{T}$$
is a vector indicating a difference between local voltages of each controllable inverter at an Nₖ-th sampling moment and an Nₖ-1-th sampling moment, Yₖ is an Nₖ-dimensional column vector,
$${Y}_{k} = {[ Δ y ( {t}_{1}^{k} ) , Δ y ( {t}_{2}^{k} ) , Δ y ( {t}_{3}^{k} ) , … , Δ y ( {t}_{{N}_{k - 1}}^{k} ) , Δ y ( {t}_{{N}_{k}}^{k} ) ]}^{T} , Δ y ( {t}_{{N}_{k}}^{k} )$$
is a measured value of a voltage change at the grid-connected point of the new energy cluster at the Nₖ-th sampling moment, T represents a transposition operation,
$${t}_{1}^{k} , {t}_{2}^{k} , {t}_{3}^{k} , … , {t}_{{N}_{k} - 1}^{k} , {t}_{{N}_{k}}^{k}$$
represent Nₖ sampling moments, elements in the data matrix Uₖ and the vector Yₖ are data measured between the (k−1)-th control moment and the k-th control moment, Nₖ≥1; and
calculating, based on the online measurement data and according to the block update recursive least squares method, the equivalent dynamic parameter vector of the data-driven dynamic linearization model to implement online real-time update of the data-driven dynamic linearization model.

11. The device according to claim 10, wherein the online real-time update comprises:
determining a size relationship between Nₖ and n, in case of Nₖ≥ n, performing calculation based on a first update formula, and in case of Nₖ<n, performing calculation based on a second update formula;
wherein the first update formula is expressed as:
$${K}_{k} = {β}^{{N}_{k}} {K}_{k - 1} + {U}_{k}^{T} {B}_{k} {U}_{k}$$
$${Θ}_{k} = {Θ}_{k - 1} + {K}_{k}^{- 1} {U}_{k}^{T} {B}_{k} ( {Y}_{k} - {U}_{k} {Θ}_{k - 1} )$$
where, Kₖ represents an information matrix at the k-th control moment, β^{N}^{ₖ} represents the Nₖ-th power of a forgetting factor β,
$${U}_{k}^{T}$$
is a transpose of the matrix Uₖ, Bₖ is an Nₖ-dimensional diagonal matrix, elements of which are composed of powers of the forgetting factor β,
$${B}_{k} = diag ( {β}^{{N}_{k - 1}} , … , 1 ) , {K}_{k}^{- 1}$$
represents an inverse matrix of the information matrix Kₖ;
wherein the second update formula is expressed as:
$${P}_{k} = \frac{{P}_{k - 1}}{{β}^{{N}_{k}}} - \frac{{P}_{k - 1}}{{β}^{{N}_{k}}} {U}_{k}^{T} ( {B}_{P k} + {U}_{k} {P}_{k - 1} {U}_{k}^{T} ) {U}_{k} {P}_{k - 1}$$
$${Θ}_{k} = {Θ}_{k - 1} + {P}_{k} {U}_{k}^{T} {B}_{k} ( {Y}_{k} - {U}_{k} {Θ}_{k - 1} )$$
where, Pₖ represents an inverse information matrix at the k-th control moment, B_{Pk} is an Nₖ-dimensional diagonal matrix, elements of which are composed of powers of the forgetting factor β, B_{Pk}=diag(β,β²,β³, . . . ,β^{N}^{ₖ}).

12. The device according to claim 11, wherein, before updating the data-driven dynamic linearization model, the method further comprises:
acquiring N₀ groups of initialization training data (U₀,Y₀); and
performing initialization on control parameters of the data-driven dynamic linearization model and the block-update recursive least squares method based on the initialization training data, wherein the control parameter of the data-driven dynamic linearization model comprises the equivalent dynamic parameter vector, and the control parameters of the block-update recursive least squares method comprise the forgetting factor, the information matrix, and the inverse information matrix;
wherein an initial value of the forgetting factor β is a preset value;
an initial value of the information matrix is:
$${K}_{0} = {U}_{0}^{T} {B}_{0} {U}_{0} + α {I}_{n}$$
where
$${U}_{0}^{T}$$
is a transpose of the matrix U₀, B₀ is an N₀-dimensional diagonal matrix, elements of which are composed of powers of the forgetting factor β, B₀=diag(β^{N}^{₀₋₁}, . . . ,1), Iₙ is an n-dimensional identity matrix, and α is a scalar greater than zero;
an initial value of the inverse information matrix is:
$${P}_{0} = {K}_{0}^{- 1}$$
where
$${K}_{0}^{- 1}$$
represents an inverse matrix of the matrix K₀;
an initial value of the equivalent dynamic parameter vector is:
$${Θ}_{0} = {P}_{0} {U}_{0}^{T} {B}_{0} {Y}_{0} .$$

13. The device according to claim 12, wherein generating, based on the data-driven dynamic linearization model updated in real time, a dynamic coordination control instruction for a coordination controller of the new energy cluster in an iterative form, and performing adaptive dynamic voltage control based on the dynamic coordination control instruction generated iteratively, comprises: for each control moment, generating, based on the data-driven dynamic linearization model updated at the control moment, a dynamic coordination control instruction for the coordination controller of the new energy cluster at the control moment, and performing adaptive dynamic voltage control based on the dynamic coordination control instruction for the coordination controller of the new energy cluster at the control moment;
wherein generating, based on the data-driven dynamic linearization model updated at the control moment, a dynamic coordination control instruction for the coordination controller of the new energy cluster at the control moment, comprises:
acquiring online measurement data at the control moment through the measurement apparatus of the new energy cluster, wherein the online measurement data at the control moment comprises measured values of the local voltages of all controllable inverters in the new energy cluster at the control moment and a measured value of the voltage at the grid-connected point of the new energy cluster at the control moment; and
generating the dynamic coordination control instruction for the coordination controller of the new energy cluster at the control moment based on the online measurement data at the control moment and the data-driven dynamic linearization model updated at the control moment;
wherein performing adaptive dynamic voltage control based on the dynamic coordination control instruction for the coordination controller of the new energy cluster at the control moment, comprises:
sending the dynamic coordination control instruction at the control moment to all controllable inverters in the new energy cluster through the coordination controller of the new energy cluster, to enable all the controllable inverters to perform control to adjust the local voltages to corresponding voltage reference instruction values.

14. The device according to claim 13, wherein the dynamic coordination control instruction at the control moment is expressed as:
$$\overline{u} ( k ) = {V}_{PVs} ( k ) + \frac{{ρ}_{CC} {Θ}_{k} ( {y}^{*} ( k ) - y ( k ) )}{{λ}_{CC} + {‖ {Θ}_{k} ‖}^{2}}$$
where λ_{CC} is a suppression factor which is a positive scalar, ρ_{CC} is a control update step size which is a positive scalar, y*(k) is a reference value of the voltage at the grid-connected point of the new energy cluster at the k-th control moment, ∥Θₖ∥² represents the 2-norm of Θdk.

15. A non-transitory computer-readable storage medium having a computer program stored thereon, wherein, when the computer program is executed on a computer, the computer is caused to perform:
constructing a data-driven dynamic linearization model for dynamic voltage control of a new energy cluster;
acquiring online measurement data through a measurement apparatus of the new energy cluster, and updating the data-driven dynamic linearization model in real time based on the online measurement data through a block update recursive least squares method; and
generating, based on the data-driven dynamic linearization model updated in real time, a dynamic coordination control instruction for a coordination controller of the new energy cluster in an iterative form, and performing adaptive dynamic voltage control based on the dynamic coordination control instruction generated iteratively.

16. The storage medium according to claim 15, wherein for the dynamic voltage control of the new energy cluster having n controllable inverters, the data-driven dynamic linearization model is expressed as:
$$Δ y ( k + 1 ) = {Θ}_{k}^{T} Δ \overline{u} ( k )$$
where, Θₖ represents an equivalent dynamic parameter vector at a k-th control moment, Θₖ is an n-dimensional column vector,
$${Θ}_{k}^{T}$$
is a transpose of Θₖ, Δy(k+1) represents a system output increment at a (k+1)-th control moment, Δy(k+1) is a scalar, Δū(k) represents a system control input increment at the k-th control moment, Δū(k) is an n-dimensional column vector, k is an integer greater than or equal to 0;
$$\begin{matrix}Δ y ( k + 1 ) = y ( k + 1 ) - y ( k ) \\ Δ \overline{u} ( k ) = \overline{u} ( k ) - {V}_{PVs} ( k )\end{matrix}$$
where, y(k+1) represents a voltage at a grid-connected point of the new energy cluster at the (k+1)-th control moment, y(k) represents a voltage at the grid-connected point of the new energy cluster at the k-th control moment, ū(k) represents a reference control instruction for local voltages of all controllable inverters in the new energy cluster at the k-th control moment, ū(k) is an n-dimensional column vector, V_{PVs}(k) represents actual measured values of the local voltages of all controllable inverters in the new energy cluster at the k-th control moment, and V_{PVs}(k) is an n-dimensional column vector.

17. The storage medium according to claim 16, wherein updating the data-driven dynamic linearization model in real time based on the online measurement data through a block update recursive least squares method comprises:
acquiring a measurement signal from the measurement apparatus of the new energy cluster to obtain Nₖ latest groups of online measurement data (Uₖ,Yₖ), where Uₖ is a data matrix with Nₖ rows and n columns,
$${U}_{k} = [ Δ {u ( {t}_{1}^{k} )}^{T} , Δ {u ( {t}_{2}^{k} )}^{T} , Δ {u ( {t}_{3}^{k} )}^{T} , … , Δ {u ( {t}_{{N}_{k - 1}}^{k} )}^{T} , Δ {u ( {t}_{{N}_{k}}^{k} )}^{T} ] , Δ {u ( {t}_{{N}_{k}}^{k} )}^{T}$$
is a vector indicating a difference between local voltages of each controllable inverter at an Nₖ-th sampling moment and an Nₖ₋₁-th sampling moment, Yₖ is an Nₖ-dimensional column vector,
$${Y}_{k} = [ Δ {y ( {t}_{1}^{k} )}^{T} , Δ {y ( {t}_{2}^{k} )}^{T} , Δ {y ( {t}_{3}^{k} )}^{T} , … , Δ {y ( {t}_{{N}_{k - 1}}^{k} )}^{T} , Δ {y ( {t}_{{N}_{k}}^{k} )}^{T} ] , Δ {y ( {t}_{{N}_{k}}^{k} )}^{T}$$
is a measured value of a voltage change at the grid-connected point of the new energy cluster at the Nₖ-th sampling moment, T represents a transposition operation,
$${t}_{1}^{k} , {t}_{2}^{k} , {t}_{3}^{k} , … , {t}_{{N}_{k - 1}}^{k} , {t}_{{N}_{k}}^{k}$$
represent Nₖ sampling moments, elements in the data matrix Uₖ and the vector Yₖ are data measured between the (k−1)-th control moment and the k-th control moment, Nₖ≥1; and
calculating, based on the online measurement data and according to the block update recursive least squares method, the equivalent dynamic parameter vector of the data-driven dynamic linearization model to implement online real-time update of the data-driven dynamic linearization model.

18. The storage medium according to claim 17, wherein the online real-time update comprises:
determining a size relationship between Nₖ and n, in case of Nₖ≥ n, performing calculation based on a first update formula, and in case of Nₖ<n, performing calculation based on a second update formula;
wherein the first update formula is expressed as:
$$\begin{matrix}{K}_{k} = {β}^{{N}_{k}} {K}_{k - 1} + {U}_{k}^{T} {B}_{k} {U}_{k} \\ {Θ}_{k} = {Θ}_{k - 1} + {K}_{k}^{- 1} {U}_{k}^{T} {B}_{k} ( {Y}_{k} - {U}_{k} {Θ}_{k - 1} )\end{matrix}$$
where, Kₖ represents an information matrix at the k-th control moment, β^{N}^{ₖ} represents the Nₖ-th power of a forgetting factor β,
$${U}_{k}^{T}$$
is a transpose of the matrix Uₖ, Bₖ is an Nₖ-dimensional diagonal matrix, elements of which are composed of powers of the forgetting factor β,
$${B}_{k} = diag ( {β}^{{N}_{k - 1}} , … , 1 ) , {K}_{k}^{- 1}$$
represents an inverse matrix of the information matrix Kₖ;
wherein the second update formula is expressed as:
$$\begin{matrix}{P}_{k} = \frac{{P}_{k - 1}}{{β}^{{N}_{k}}} - \frac{{P}_{k - 1}}{{β}^{{N}_{k}}} {U}_{k}^{T} ( {B}_{Pk} + {U}_{k} {P}_{k - 1} {U}_{k}^{T} ) {U}_{k} {P}_{k - 1} \\ {Θ}_{k} = {Θ}_{k - 1} + {P}_{k} {U}_{k}^{T} {B}_{k} ( {Y}_{k} - {U}_{k} {Θ}_{k - 1} )\end{matrix}$$
where, Pₖ represents an inverse information matrix at the k-th control moment, B_{Pk} is an Nₖ-dimensional diagonal matrix, elements of which are composed of powers of the forgetting factor β, B_{Pk}=diag(β,β²,β³, . . . ,β^{N}^{ₖ}).

19. The storage medium according to claim 18, wherein, before updating the data-driven dynamic linearization model, the method further comprises:
acquiring N₀ groups of initialization training data (U₀, Y₀); and
performing initialization on control parameters of the data-driven dynamic linearization model and the block-update recursive least squares method based on the initialization training data, wherein the control parameter of the data-driven dynamic linearization model comprises the equivalent dynamic parameter vector, and the control parameters of the block-update recursive least squares method comprise the forgetting factor, the information matrix, and the inverse information matrix;
wherein an initial value of the forgetting factor β is a preset value;
an initial value of the information matrix is:
$${K}_{0} = {U}_{0}^{T} {B}_{0} {U}_{0} + α {I}_{n}$$
where
$${U}_{0}^{T}$$
is a transpose of the matrix U₀, B₀ is an N₀-dimensional diagonal matrix, elements of which are composed of powers of the forgetting factor β, B₀=diag(β^{N}^{₀₋₁}, . . . ,1), Iₙ is an n-dimensional identity matrix, and α is a scalar greater than zero;
an initial value of the inverse information matrix is:
$${P}_{0} = {K}_{0}^{- 1}$$
where
$${K}_{0}^{- 1}$$
represents an inverse matrix of the matrix K₀;
an initial value of the equivalent dynamic parameter vector is:
$${Θ}_{0} = {P}_{0} {U}_{0}^{T} {B}_{0} {Y}_{0} .$$

20. The storage medium according to claim 19, wherein generating, based on the data-driven dynamic linearization model updated in real time, a dynamic coordination control instruction for a coordination controller of the new energy cluster in an iterative form, and performing adaptive dynamic voltage control based on the dynamic coordination control instruction generated iteratively, comprises: for each control moment, generating, based on the data-driven dynamic linearization model updated at the control moment, a dynamic coordination control instruction for the coordination controller of the new energy cluster at the control moment, and performing adaptive dynamic voltage control based on the dynamic coordination control instruction for the coordination controller of the new energy cluster at the control moment;
wherein generating, based on the data-driven dynamic linearization model updated at the control moment, a dynamic coordination control instruction for the coordination controller of the new energy cluster at the control moment, comprises:
acquiring online measurement data at the control moment through the measurement apparatus of the new energy cluster, wherein the online measurement data at the control moment comprises measured values of the local voltages of all controllable inverters in the new energy cluster at the control moment and a measured value of the voltage at the grid-connected point of the new energy cluster at the control moment; and
generating the dynamic coordination control instruction for the coordination controller of the new energy cluster at the control moment based on the online measurement data at the control moment and the data-driven dynamic linearization model updated at the control moment;
wherein performing adaptive dynamic voltage control based on the dynamic coordination control instruction for the coordination controller of the new energy cluster at the control moment, comprises:
sending the dynamic coordination control instruction at the control moment to all controllable inverters in the new energy cluster through the coordination controller of the new energy cluster, to enable all the controllable inverters to perform control to adjust the local voltages to corresponding voltage reference instruction values.
